(19) United States
(12) Patent Application Publication
(10) Pub. No.: US 2025/0102471 A1
(43) Pub. Date: Mar. 27, 2025

(54) ULTRASONIC PHASED ARRAY INSPECTION DEVICE AND ULTRASONIC PHASED ARRAY INSPECTION METHOD USING THE SAME

(71) Applicant: HITACHI ZOSEN CORPORATION, Osaka-shi, Osaka (JP)

(72) Inventors: Kaoru SHINODA, Osaka-shi, Osaka (JP); Yuichi KOBAYASHI, Osaka-shi, Osaka (JP); Takeru KATAYAMA, Osaka-shi, Osaka (JP); Masamitsu ABE, Osaka-shi, Osaka (JP); Joichi MURAKAMI, Osaka-shi, Osaka (JP); Naoto SHINMURA, Osaka-shi, Osaka (JP); Hiroyuki MARUYAMA, Osaka-shi, Osaka (JP)

(21) Appl. No.: 18/726,140

(22) PCT Filed: Nov. 29, 2022
(86) PCT No.: PCT/JP2022/043946

§ 371 Date: Jul. 2, 2024

(30) Foreign Application Priority Data
Jan. 14, 2022 (JP) 2022-004027

(51) Int. Cl. G01N 29/26; G01N 29/24; G01N 29/265

(52) U.S. Cl. CPC G01N 29/262; G01N 29/2437; G01N 29/265

(57) ABSTRACT

An ultrasonic phased array inspection device includes flexible plates, array probes, and a connection body. The flexible plates extend along an inner circumferential surface of a tube. The array probes are disposed on the flexible plates and send and receive an ultrasonic wave based on the phased array technique. The array probes have a set of a predetermined number of piezoelectric elements arranged in the inner circumferential direction of the tube. The connection body is connected to the flexible plates. The connection body has pulled parts that are pulled in the axial direction of the tube as force receiving parts that receive a force to make the connection body move in the axial direction of the tube.

### TECHNICAL FIELD

The present invention relates to an ultrasonic phased array inspection device and an ultrasonic phased array inspection method using the same.

### BACKGROUND ART

An inspection device using ultrasonic waves, such as an ultrasonic phased array inspection device, is used for inspection of a tube, specifically, detection of a flaw in a tube and measurement of the thickness of a tube. Japanese Patent Laid-Open No. 2-32250 (hereinafter referred to as Patent Literature 1) proposes a conventional inspection device (tube inspection device) that requires no special sensor fitting. With the inspection device described in Patent Literature 1, a large number of grooves extending in the axial direction of the tube are formed in a fin. The large number of grooves are provided to cope with any obstacle in the tube.

### SUMMARY OF INVENTION

### Technical Problem

With the inspection device described in Patent Literature 1, however, a set of piezoelectric elements required for the phased array technique cannot be arranged in the inner circumferential direction of the tube because of the large number of grooves extending in the axial direction of the tube. Therefore, the inspection device described in Patent Literature 1 cannot use the phased array technique and therefore has a problem that inspection of the tube, such as flaw detection and thickness measurement, cannot be performed with high precision.

The present invention has been devised in view of the problem, and an object of the present invention is to provide an ultrasonic phased array inspection device that can inspect a tube with high precision and an ultrasonic phased array inspection method using the same.

### Solution to Problem

According to an aspect of the present invention, an ultrasonic phased array inspection device includes a flexible plate, an array probe, and a connection body. The flexible plate extends along an inner circumferential surface of a tube. The array probe is disposed on the flexible plate and sends and receives an ultrasonic wave based on the phased array technique. The array probe has a set of a predetermined number of piezoelectric elements arranged in an inner circumferential direction of the tube. The connection body is connected to the flexible plate. The connection body has a force receiving part that receives a force to make the connection body move in an axial direction of the tube.

### Advantageous Effects of Invention

With the ultrasonic phased array inspection device and the ultrasonic phased array inspection method using the same according to the present invention, a tube can be inspected with high precision.

### BRIEF DESCRIPTION OF DRAWINGS

FIG. 1 is a schematic perspective view of an ultrasonic phased array inspection device according to an embodiment.

FIG. 2 is a longitudinal cross-sectional view of the ultrasonic phased array inspection device inserted in a tube viewed from above.

FIG. 3 is a longitudinal cross-sectional view of the ultrasonic phased array inspection device inserted in the tube viewed from a side.

FIG. 4 is a cross-sectional view taken along the line IV-IV in FIG. 3.

FIG. 5 is a cross-sectional view taken along the line V-V in FIG. 3.

FIG. 6 is a perspective view of an advancing winding device or a retracting winding device.

FIG. 7 is a longitudinal cross-sectional view for illustrating an ultrasonic phased array inspection method, which shows the first half of a connection body installation step.

FIG. 8 is a longitudinal cross-sectional view for illustrating the ultrasonic phased array inspection method, which shows the second half of the connection body installation step.

FIG. 9 is a longitudinal cross-sectional view for illustrating the ultrasonic phased array inspection method, which shows a preliminary movement step of moving to an inspection start position.

FIG. 10 is a longitudinal cross-sectional view for illustrating the ultrasonic phased array inspection method, which shows the first half of an inspection step.

FIG. 11 is a longitudinal cross-sectional view for illustrating the ultrasonic phased array inspection method, which shows the second half of the inspection step.

FIG. 12 is a longitudinal cross-sectional view showing the end of the ultrasonic phased array inspection method.

FIG. 13 is a plan view of a protection film that protects an array probe of the ultrasonic phased array inspection device.

FIG. 14 is a bottom view of the protection film.

FIG. 15 is a schematic perspective view of an ultrasonic phased array inspection device according to a variation.

FIG. 16 is a schematic perspective view of a traction jig for the ultrasonic phased array inspection device.

FIG. 17 is a longitudinal cross-sectional view for illustrating an ultrasonic phased array inspection method using the traction jig, which shows the first half of a connection body installation step.

FIG. 18 is a longitudinal cross-sectional view for illustrating the ultrasonic phased array inspection method using the traction jig, which shows the second half of the connection body installation step.

FIG. 19 is a longitudinal cross-sectional view for illustrating the ultrasonic phased array inspection method using the traction jig, which shows a preliminary movement step of moving to an inspection start position.

### DESCRIPTION OF EMBODIMENTS

In the following, embodiments will be described with reference to the drawings. In the drawings, the same or corresponding parts are denoted by the same reference numerals, and redundant descriptions will be omitted. In the description below, any term indicating a particular position or direction, such as up, down, left, right, front or rear, is used for convenience for facilitating the understanding of the embodiments and does not mean direction in the actual implementation.

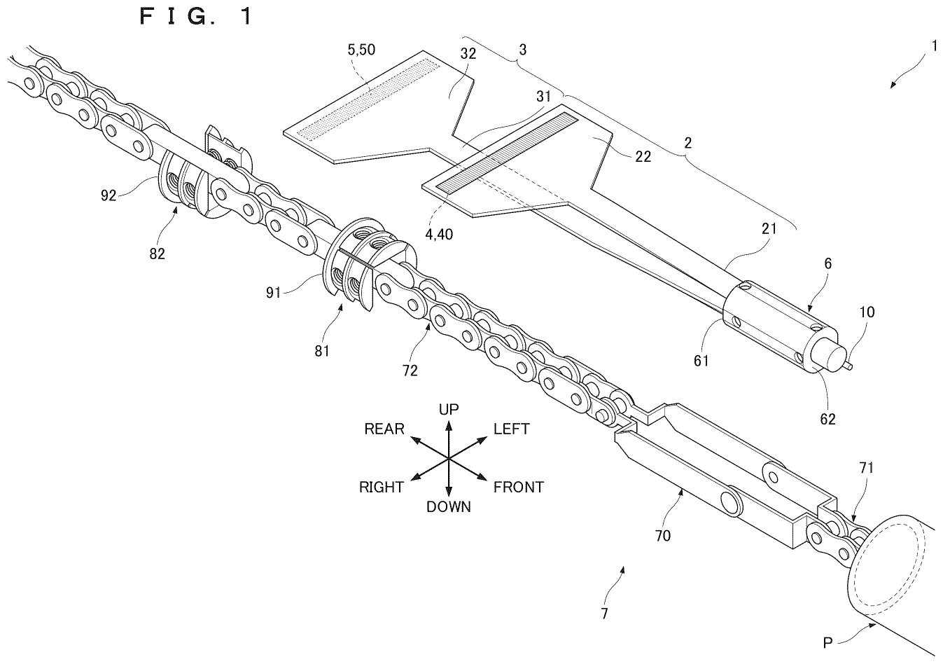

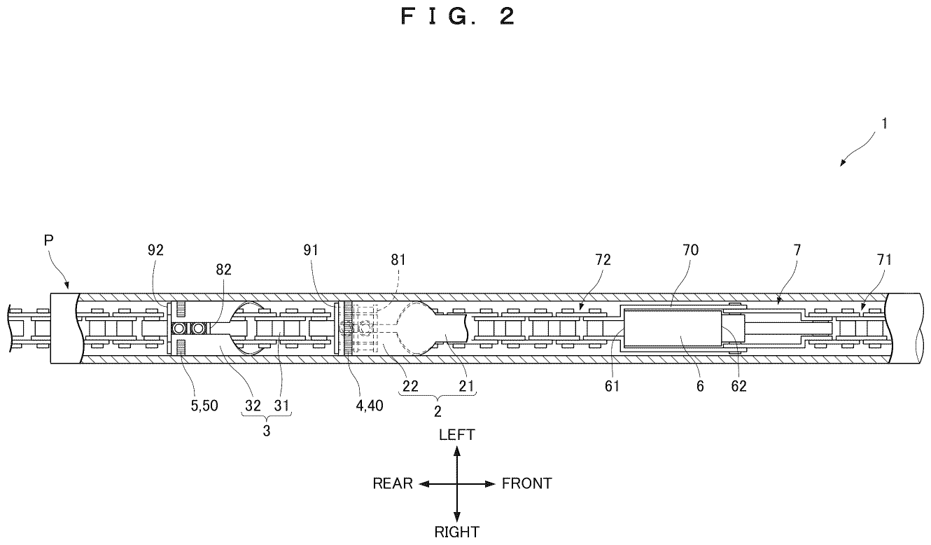

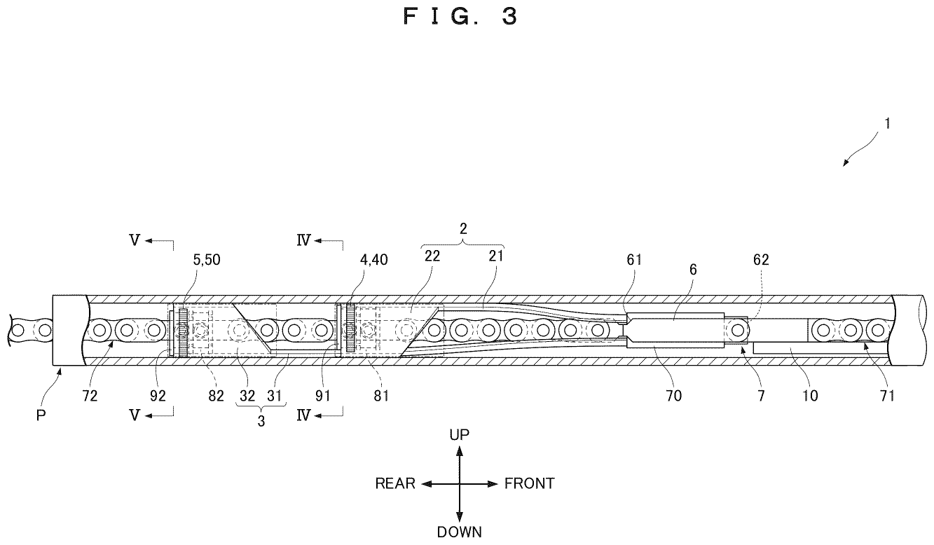

With reference to FIGS. 1 to 3, an ultrasonic phased array inspection device 1 according to an embodiment will be described. FIG. 1 is a schematic perspective view of the ultrasonic phased array inspection device 1. FIG. 2 is a longitudinal cross-sectional view of the ultrasonic phased array inspection device 1 inserted in a tube P viewed from above. FIG. 3 is a longitudinal cross-sectional view of the ultrasonic phased array inspection device 1 inserted in the tube P viewed from a side.

The ultrasonic phased array inspection device 1 is a device that performs inspection, specifically, detection of a flaw in the tube P and/or measurement of the thickness of the tube P. The tube P to be inspected is not particularly limited. The tube P may be any of various kinds of tubes, such as a tube of a heat exchanger, a tube having a test tube-like shape or a boiler tube.

As shown in FIGS. 1 to 3, the ultrasonic phased array inspection device 1 includes flexible plates 2 and 3, array probes 4 and 5, and a connection body 6. The flexible plates 2 and 3 extend along an inner circumferential surface of the tube P to be inspected. The array probes 4 and 5 are disposed on the flexible plate 2 and 3, respectively, and sends and receives an ultrasonic wave based on the phased array technique. The array probe 4 has a set of a predetermined number (a number required for the phased array technique) of piezoelectric elements 40 arranged in the circumferential direction of the tube P, and the array probe 5 has a set of a predetermined number (a number required for the phased array technique) of piezoelectric elements 50 arranged in the circumferential direction of the tube P. The connection body 6 is connected to the flexible plates 2 and 3. The connection body 6 has pulled parts 61 and 62 to be pulled in the axial direction of the tube P. In the following, of the axial direction of the tube P, a direction in which the inspection proceeds will be referred to as a forward direction, and a direction opposite to the forward direction will be referred to as a backward direction. Directions perpendicular to the forward direction and the backward direction will be referred to as a left direction and a right direction.

Next, an ultrasonic phased array inspection method using the ultrasonic phased array inspection device 1 will be described.

The ultrasonic phased array inspection method includes an inspection step. In the inspection step, flaw detection is performed with the array probes 4 and 5 while moving the connection body 6 by pulling the pulled parts 61 and 62 of the connection body 6. In the inspection step, measurement of the thickness of the tube P may be performed with the array probes 4 and 5.

With the ultrasonic phased array inspection device 1 and the ultrasonic phased array inspection method, the array probes 4 and 5 disposed on the flexible plates 2 and 3 extending along the inner circumferential surface of the tube P send and receive an ultrasonic wave based on the phased array technique, so that the inner circumferential surface of the tube P is inspected with high precision. Furthermore, the connection body 6 connected to the array probes 4 and 5 is pulled at the pulled parts 61 and 62 thereof in the axial direction of the tube P, so that the inner circumferential surface of the tube P is inspected with high precision in the axial direction. Therefore, the ultrasonic phased array inspection device 1 and the ultrasonic phased array inspection method can inspect the tube P with high precision.

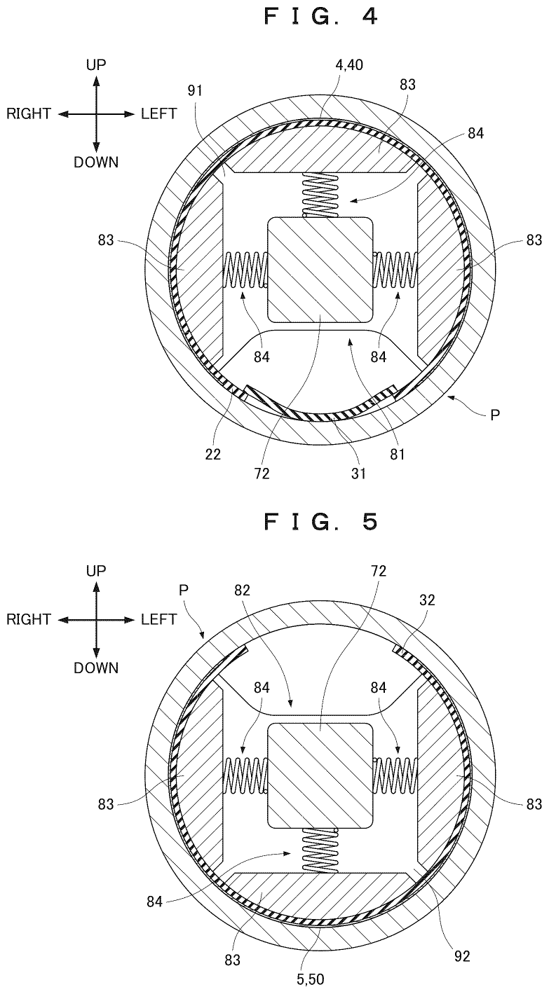

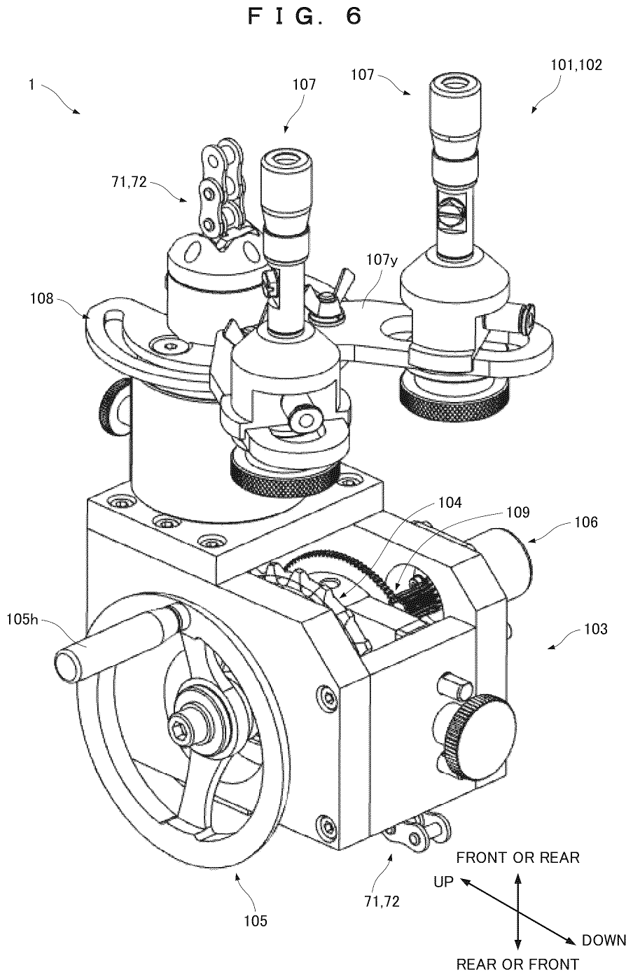

In the following, with reference to FIGS. 1 to 6, the ultrasonic phased array inspection device 1 will be described in more detail. FIG. 4 is a cross-sectional view taken along the line IV-IV in FIG. 3. FIG. 5 is a cross-sectional view taken along the line V-V in FIG. 3. FIG. 6 is a perspective view of an advancing winding device 101 and a retracting winding device 102.

As shown in FIGS. 1 to 3, the number of the flexible plates 2 and 3 is two (any plurality of flexible plates is possible). The flexible plate 2 has a stem part 21 and a spatula part 22, and the flexible plate 3 has a stem part 31 and a spatula part 32. The stem parts 21 and 31 are connected to the connection body 6 at the respective front ends and connected to the respective spatula parts 22 and 32 at the respective rear ends. The spatula parts 22 and 32 are made of a material that can bend along the inner circumferential surface of the tube P. For example, the spatula parts 22 and 32 are made of an elastic material, such as rubber. The spatula parts 22 and 32 each have a portion that is wider toward the rear and a rectangular portion. The array probe 4 is disposed on the rectangular portion of the spatula part 22, and the array probe 5 is disposed on the rectangular portion of the spatula part 32. The array probes 4 and 5 are electrically connected to a probe cable 10. The array probes 4 and 5 can arbitrarily change the propagation direction and the propagation range of the ultrasonic wave by adjusting the timings of oscillation of the piezoelectric elements 40 and 50, respectively. The array probes 4 and 5 are capable of both linear scanning and sector scanning.

The two stem parts 21 and 31 have different lengths. Therefore, the array probe 4 disposed on the flexible plate 2 having the shorter stem part 21 and the array probe 5 disposed on the flexible plate 3 having the longer stem part 31 are located at different positions in the axial direction of the tube P. In other words, the two array probes 4 and 5 are located at different positions in the forward/backward direction. The distance between the two array probes 4 and 5 is appropriately determined based on the inner diameter of the tube P and the curvature of a U-bend part of the tube P.

Therefore, the two array probes 4 and 5 do not interfere with each other when passing through the U-bend part of the tube P. Therefore, the tube P having the U-bend part can be inspected with high precision.

Preferably, the spatula part 22 connected to the shorter stem part 21 and the spatula part 32 connected to the longer stem part 31 are located at different positions in the axial direction of the tube P. In other words, the two spatula parts 22 and 32 are located at different positions in the forward/backward direction.

Therefore, the two spatula parts 22 and 32 do not interfere with each other when passing through the U-bend part of the tube P. Therefore, the tube P having the U-bend part can be inspected with higher precision.

The pulled parts 61 and 62 of the connection body 6 are specifically an advancing pulled part 61 and a retracting pulled part 62. The advancing pulled part 61 is pulled in one direction (forward direction) along the axial direction of the tube P. The retracting pulled part 62 is pulled in the other direction (backward direction) along the axial direction of the tube P.

The pulled parts 61 and 62 of the connection body 6 are pulled in the forward direction and the backward direction respectively by being the advancing pulled part 61 and the retracting pulled part 62. When the connection body 6 is being pulled in the forward direction in the tube P, the connection body 6 may be caught in the tube P. In such a case, the connection body 6 can be pulled in the backward direction to make the connection body 6 move in the opposite direction (or to retract the connection body 6), thereby clearing the clogging of the tube P. Similarly, when the connection body 6 is being pulled in the backward direction in the tube P, the connection body 6 and large-diameter members 81 and 82 described later may be caught in the tube P. In such a case, the connection body 6 can be pulled in the forward direction to make the connection body 6 move in the opposite direction (or to advance the connection body 6), thereby clearing the clogging of the tube P. In this way, the advancing pulled part 61 and the retracting pulled part 62 facilitate clearing of the clogging of the tube P with the connection body 6 and the large-diameter members 81 and 82.

The ultrasonic phased array inspection device 1 further includes a traction fitting 7 for pulling the pulled parts 61 and 62. The traction fitting 7 includes a frame holder 70, an advancing chain 71 (an example of an advancing traction member), a retracting chain 72 (an example of a retracting traction member), a first flange part 91, a second flange part 92 and the large-diameter members 81 and 82. Specifically, the large-diameter members 81 and 82 are a first large-diameter member 81 and a second large-diameter member 82.

The frame holder 70 is a frame that surrounds and holds the connection body 6 at the front, rear and sides of the connection body 6. The frame holder 70 comes into contact with a rear surface 61 and a front surface 62 of the connection body 6. Therefore, the frame holder 70 transmits an advancing force to the rear surface 61 of the connection body 6, and transmits a retracting force to the front surface 62 of the connection body 6. Therefore, the rear surface 61 of the connection body 6 constitutes the advancing pulled part 61, and the front surface 62 of the connection body 6 constitutes the retracting pulled part 62.

The advancing chain 71 is connected to a front end part of the frame holder 70. The retracting chain 72 is connected to a rear end part of the frame holder 70. The advancing chain 71 and the retracting chain 72 are both roller chains, for example. The advancing chain 71 and the retracting chain 72 have the same pin direction, that is, bend in the same direction. The retracting chain 72 is provided with the first flange part 91, the second flange part 92, the first large-diameter member 81 and the second large-diameter member 82.

Since the advancing chain 71 and the retracting chain 72 are roller chains, the advancing chain 71 and the retracting chain 72 bend along the U-bend part of the tube P and therefore smoothly pass through the U-bend part. Therefore, the tube P having the U-bend part can also be inspected with high precision.

As shown in FIGS. 2 and 3, the first flange part 91 comes into contact with a rear end of the spatula part 22 connected to the shorter stem part 21. Therefore, the first flange part 91 transmits an advancing force to the flexible plate 2 having the shorter stem part 21. As shown in FIG. 4, the first flange part 91 leaves a space through which the longer stem part 31 passes in the forward/backward direction. As shown in FIGS. 2 and 3, the second flange part 92 comes into contact with a rear end of the spatula part 32 connected to the longer stem part 31. Therefore, the second flange part 92 transmits an advancing force to the flexible plate 3 having the longer stem part 31.

As shown in FIG. 4, the first large-diameter member 81 presses the spatula part 22 against the inner circumferential surface of the tube P at the part where the array probe 4 is disposed. Similarly, as shown in FIG. 5, the second large-diameter member 82 presses the spatula part 32 against the inner circumferential surface of the tube P at the part where the array probe 5 is disposed. To this end, as shown in FIGS. 4 and 5, each of the first large-diameter member 81 and the second large-diameter member 82 has three pressing parts 83 and three compression springs 84. The three pressing parts 83 have an outer circumferential that shape conforms to the inner of the tube P. The three circumferential surface compression springs 84 urge the three pressing parts 83 from the retracting chain 72 to the inner circumferential surface of the tube P.

As shown in FIG. 4, the array probe 4 disposed on the spatula part 22 extends from a lower right position to the top and then to a lower left position in the inner circumferential direction of the tube P. As shown in FIG. 5, the array probe 5 disposed on the spatula part 32 extends from a upper right position to the bottom and then to a upper left position in the inner circumferential direction of the tube P. Therefore, as shown in FIGS. 4 and 5, the two array probes 4 and 5 cover at least the entire length in the inner circumferential direction of the tube P. In other words, the two array probes 4 and 5 are disposed over the entire length in the inner circumferential direction of the tube P. Therefore, the inner circumferential surface of the tube P is inspected over the entire length in the circumferential direction with the two array probes 4 and 5. As a result, the tube P can be inspected with higher precision.

As shown in FIG. 6, the ultrasonic phased array inspection device 1 further includes an advancing winding device 101 and a retracting winding device 102. The advancing winding device 101 winds up the advancing chain 71. The retracting winding device 102 winds up the retracting chain 72.

Since the ultrasonic phased array inspection device 1 includes the advancing winding device 101 and the retracting winding device 102, the advancing chain 71 and the retracting chain 72 are under tension in the inspection. Therefore, the tube P can be inspected with higher precision.

The advancing winding device 101 and the retracting winding device 102 may have the same configuration. For example, each of the advancing winding device 101 and the retracting winding device 102 includes a housing 103, a sprocket 104, a set of gear and pinion 109, a manual handle 105 with a grip 105h, a small encoder 106, air pickers 107 fixed to a Y-shaped jig 107y, and a circumferential position adjuster 108.

The housing 103 rotatably houses the sprocket 104 and the set of gear and pinion 109. The advancing chain 71 or the retracting chain 72 is wound around the sprocket 104. The sprocket 104 rotates to feed the advancing chain 71 or the retracting chain 72 while turning the chain around from the forward/backward direction to the up/down direction. The manual handle 105 is disposed outside the housing 103. The manual handle 105 transmits a rotation caused by hand to the sprocket 104. The distance between the axis of rotation of the manual handle 105 and the grip 105h is equal to or less than 130% of the radius of the sprocket 104. That is, the manual handle 105 is small. The small encoder 106 measures the rotational speed of the sprocket 104 based on the rotation of the sprocket 104 transmitted by the set of gear and pinion 109. The air pickers 107 can be fixed to tubes other than the tube P to be inspected. The circumferential position adjuster 108 allows adjustment and fixing of the position of the Y-shaped jig 107y (the position in the circumferential direction of a circle centered on the advancing chain 71 or the retracting chain 72 extending in the forward/backward direction). The Y-shaped jig adjustment and fixing of the positions of the air pickers 107 (positions closer to or farther from the advancing chain 71 or the retracting chain 72 extending in the forward/backward direction).

When the manual handle 105 is manually rotated in the state where the air pickers 107 are fixed to the tubes other than the tube P to be inspected, the sprocket 104 also rotates to feed the advancing chain 71 or the retracting chain 72 in the forward direction or the backward direction.

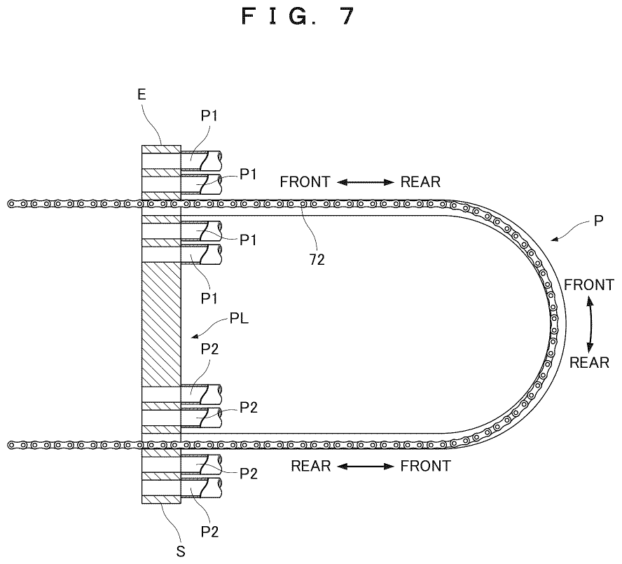

Next, with reference to FIGS. 7 to 12, the ultrasonic phased array inspection method will be described in more detail. The ultrasonic phased array inspection method includes a connection body installation step and a preliminary movement step before the inspection step.

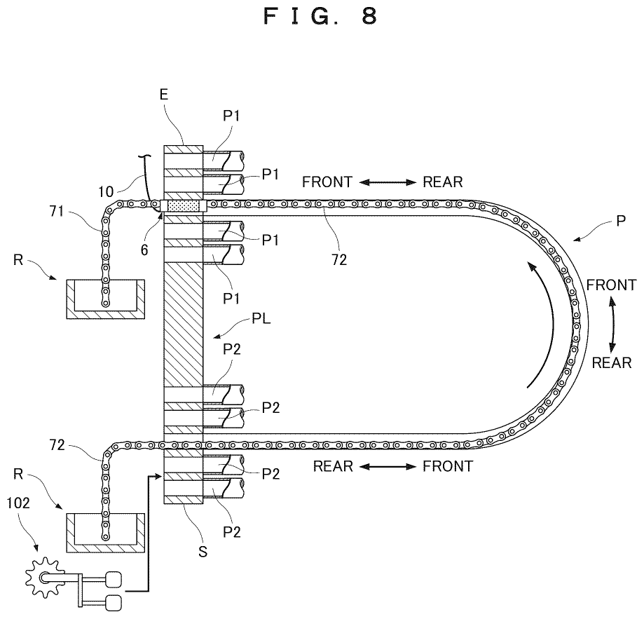

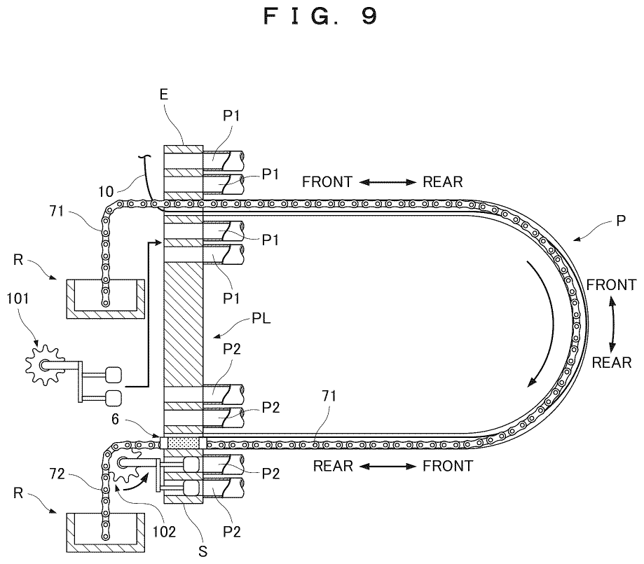

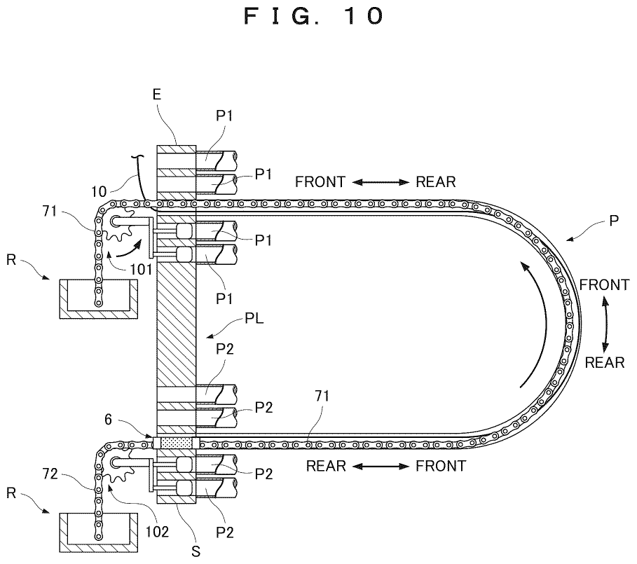

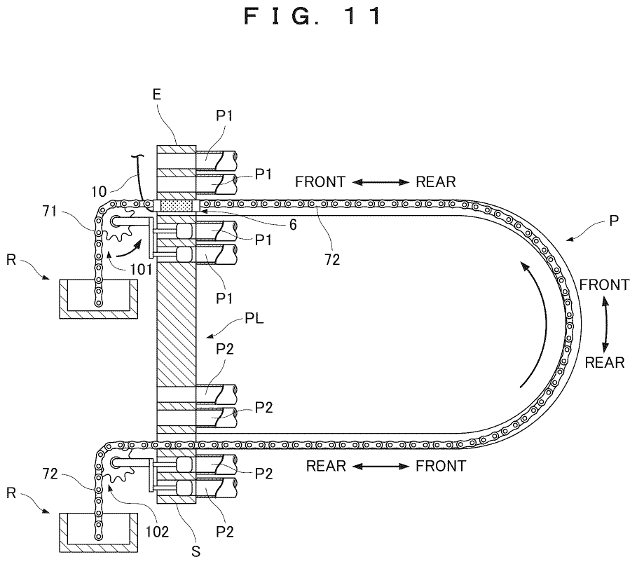

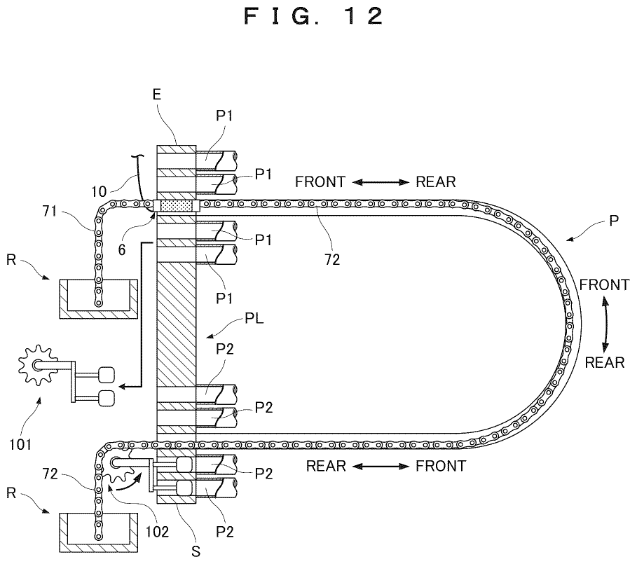

FIG. 7 is a longitudinal cross-sectional view for illustrating the ultrasonic phased array inspection method, which shows the first half of the connection body installation step. FIG. 8 is a longitudinal cross-sectional view for illustrating the ultrasonic phased array inspection method, which shows the second half of the connection body installation step. FIG. 9 is a longitudinal cross-sectional view for illustrating the ultrasonic phased array inspection method, which shows the preliminary movement step. FIG. 10 is a longitudinal cross-sectional view for illustrating the ultrasonic phased array inspection method, which shows the first half of the inspection step. FIG. 11 is a longitudinal cross-sectional view for illustrating the ultrasonic phased array inspection method, which shows the second half of the inspection step. FIG. 12 is a longitudinal cross-sectional view showing the end of the ultrasonic phased array inspection method.

As shown in FIG. 7, in the connection body installation step, the retracting chain 72 is passed through the tube P to be inspected. The tube P to be inspected is a tube P of a heat exchanger (an example of the tube P having a U-bend part), and therefore, the tube P is connected to a tube plate PL and is adjacent to a plurality of tubes P1 and P2. The retracting chain 72 may be passed through the tube P from an inspection end side E (one end) to an inspection start side S (the other end) of the tube P or from the inspection start side S (the other end) to the inspection end side E (one end) of the tube P.

As shown in FIG. 8, in the connection body installation step, the connection body 6 is then installed at the inspection end side E of the tube P. The advancing chain 71 and the retracting chain 72 are then connected to the connection body 6. The connection between the connection body 6 and the advancing chain 71 and the retracting chain 72 may be achieved by the frame holder 70 of the traction fitting 7 holding the connection body 6. Furthermore, the retracting winding device 102 is fixed to the tubes P2 adjacent to (or in the vicinity of) the inspection start side S of the tube P. The retracting chain 72 is then passed through the retracting winding device 102 so that the retracting winding device 102 can wind up the retracting chain 72. Any excess part of the advancing chain 71 and the retracting chain 72 may be accommodated in a chain reservoir R.

As shown in FIG. 9, in the preliminary movement step, the retracting winding device 102 then winds up the retracting chain 72. As a result, the connection body 6 is pulled in the backward direction and moves to the inspection start side S of the tube P. In other words, the retracting pulled part 62 of the connection body 6 is pulled to move the connection body 6 from one end E to the other end S of the tube P. In addition, the advancing winding device 101 is fixed to the tubes P1 adjacent to (or in the vicinity of) the inspection end side E of the tube P. The advancing chain 71 is then passed through the advancing winding device 101 so that the advancing winding device 101 can wind up the advancing chain 71.

As shown in FIGS. 10 and 11, in the inspection step, the advancing winding device 101 then winds up the advancing chain 71. As a result, the connection body 6 is pulled in the forward direction, and flaw detection is performed with the array probes 4 and 5 while the connection body 6 moves to the inspection end side E of the tube P. In other words, while the advancing pulled part 61 of the connection body 6 is pulled to move the connection body 6 from the other end S to the one end E of the tube P, flaw detection is performed with the array probes 4 and 5. When the connection body 6 reaches the one end E, the flaw detection ends. In the inspection step, not only the flaw detection but also measurement of the thickness of the tube P can be performed with the array probes 4 and 5. When the connection body 6 is caught in the tube P in the flaw detection, the retracting chain 72 is wound up by the retracting winding device 102. In this way, the clogging of the tube P with the connection body 6 can be cleared.

As shown in FIG. 12, finally, the advancing chain 71 is removed from the connection body 6, and the advancing winding device 101 is removed from the tube P1. The retracting chain 72 is then removed from the connection body 6. After that, the retracting chain 72 is wound up by the retracting winding device 102. After the retracting chain 72 is wound up and removed out of the other end S of the tube P, the retracting winding device 102 is also removed from the tube P2.

Since the ultrasonic phased array inspection method includes the connection body installation step and the preliminary movement step before the inspection step, the connection body 6 passes through the tube P before the flaw detection, so that the connection body 6 is less likely to be caught in the tube P in the flaw detection. Therefore, the tube P can be inspected with high precision.

The embodiments of the present invention have been described with reference to the drawings. However, the present invention is not limited to the embodiments, and various other implementations are possible without departing from the spirit of the present invention. The drawings are schematic diagrams showing main components for ease of understanding, and the thickness and length of each component, the numbers of the components, the distances between the components and the like shown in the drawings are different from those in the actual implementation for convenience of drawing. The speed, material, shape, dimensions and the like of each component shown in the embodiments are just examples and are not intended to limit the present invention, and various modifications can be made without substantially departing from the configuration according to the present invention.

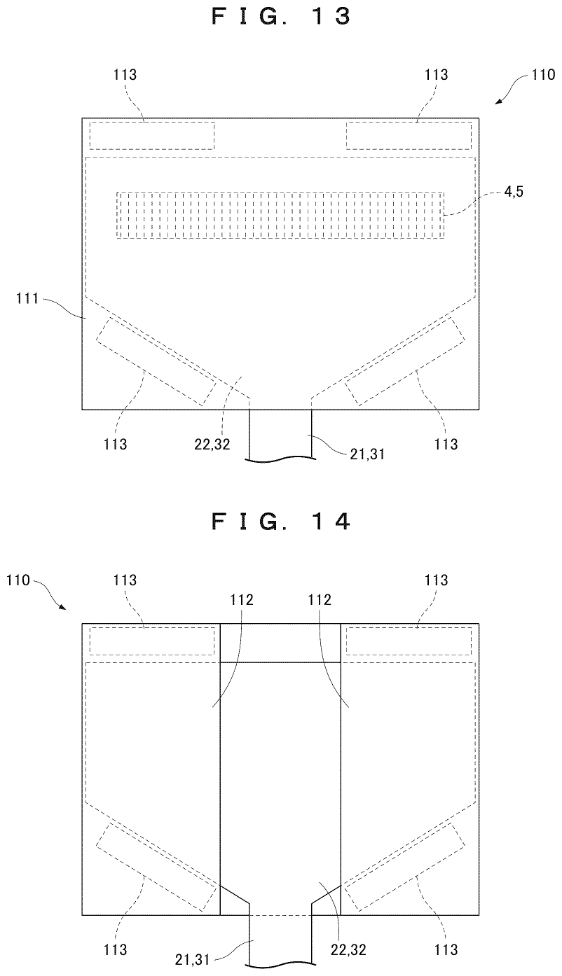

In the embodiments, no protection for the array probes 4 and 5 has been described. As shown in FIGS. 13 and 14, however, the ultrasonic phased array inspection device 1 may further include a protection film 110 for protecting the array probes 4 and 5 and the spatula parts 22 and 32. The protection film 110 includes an outer transparent film 111, an inner transparent film 112 and a bonding part 113. The outer transparent film 111 is preferably a hydrophilic film. If the outer transparent film 111 is a hydrophilic film, water droplets are less likely to be formed on the outer transparent film 111, and therefore reflection of the ultrasonic wave from water droplets, which is a cause of noise, is prevented. The bonding part 113 bonds the outer transparent film 111 and the inner transparent film 112 to each other. The bonding part 113 is an adhesive or a double-faced tape, for example. The double-faced tape is preferably waterproof.

As shown in FIG. 13, the outer transparent film 111 covers the entire surface of the spatula parts 22 and 32 on the side on which the array probes 4 and 5 are disposed. As shown in FIG. 14, the inner transparent film 112 covers the spatula parts 22 and 32 on the side on which the array probes 4 and 5 are not disposed. The inner transparent film 112 does not cover a central part of the spatula parts 22 and 32 that corresponds to an extension of the stem parts 21 and 31. Therefore, the part of the inner transparent film 112 that does not cover the spatula parts 22 and 32 serves as an opening through which the spatula parts 22 and 32 are removed or inserted.

The opening through which the spatula parts 22 and 32 are removed or inserted facilitates replacement of the protection film 110 for the spatula parts 22 and 32. When the spatula parts 22 and 32 extend along the inner circumferential surface of the tube P, the inner transparent film 112 is located on the inner side of the curved spatula parts 22 and 32. Since the inner transparent film 112 has the opening, the inner transparent film 112 can be prevented from being wrinkled because of the curving.

In the embodiments, no coupling medium required for the flaw detection with the ultrasonic wave has not been described. However, a coupling medium (such as water or glycerin) may be supplied to the gap between the spatula parts 22 and 32 and the inner circumferential surface of the tube P. The coupling medium may also be supplied to the gap between the spatula parts 22 and 32 and the outer transparent film 111.

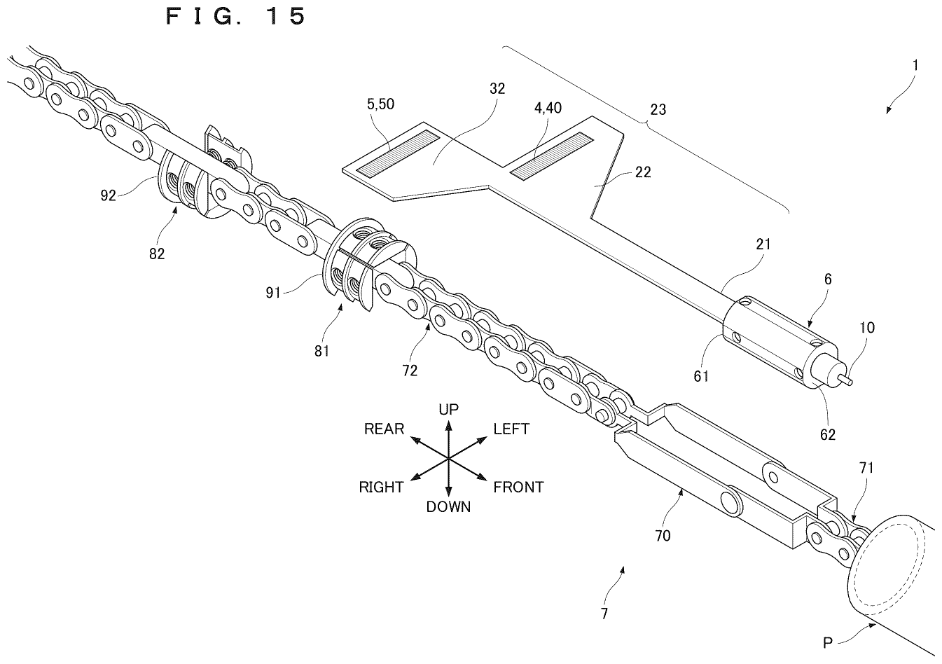

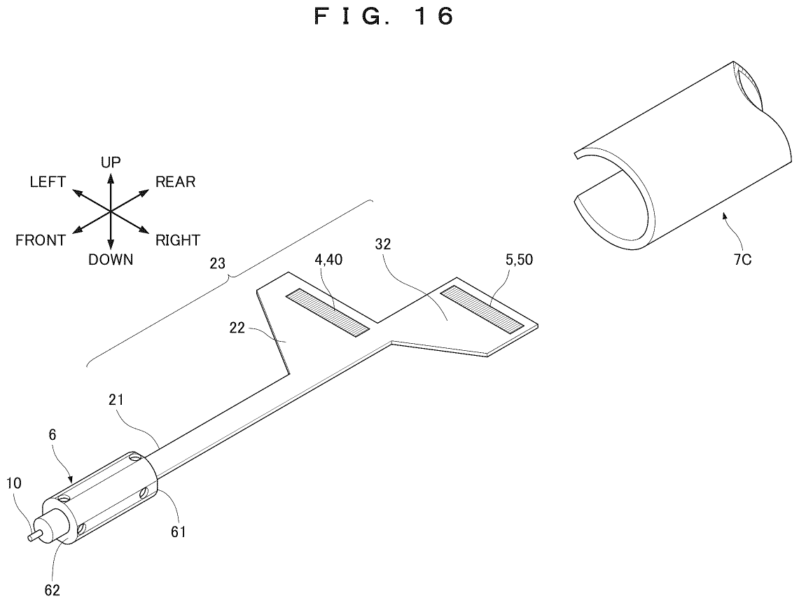

In the embodiments, as shown in FIG. 1, two flexible plates 2 and 3 (or a plurality of flexible plates) have been described. As shown in FIG. 15, however, there may be only one flexible plate 23. The one flexible plate 23 has a stem part 21, a left spatula part 22 and a right spatula part 32. The left spatula part 22 is located forward (or rearward) of the right spatula part 32. The two array probes 4 and 5 are disposed on the left spatula part 22 and the right spatula part 32, respectively. Therefore, the two array probes 4 and 5 are located at different positions in the forward/backward direction. The left spatula part 22 projects to the left from a stem part 21. The right spatula part 32 projects to the right from an extension of the stem part 21 in the backward direction. The array probes 4 and 5 disposed on the left spatula part 22 and the right spatula part 32, respectively, cover at least the entire length in the inner circumferential direction of the tube P in which the two array probes 4 and 5 are inserted. In other words, the two array probes 4 and 5 are disposed over the entire length in the inner circumferential direction of the tube P.

In the embodiments, the connection body 6 has been described as having the pulled parts 61 and 62 that are to be pulled in the axial direction of the tube P. The connection body 6 is not limited to having the pulled parts 61 and 62 and can have any force receiving part for receiving a force to make the connection body 6 move (including scan) in the axial direction of the tube P. As the force to make the connection body 6 move in the axial direction of the tube P, the force receiving part receives a pressing force from a pressing member, a pressure such as water pressure or air pressure, or a negative pressure such as water pressure or air pressure. The pressing member can be inserted into the tube P and has a bar-like shape, for example. When the tube P has a U-bend part, the pressing member is preferably flexible to be curved.

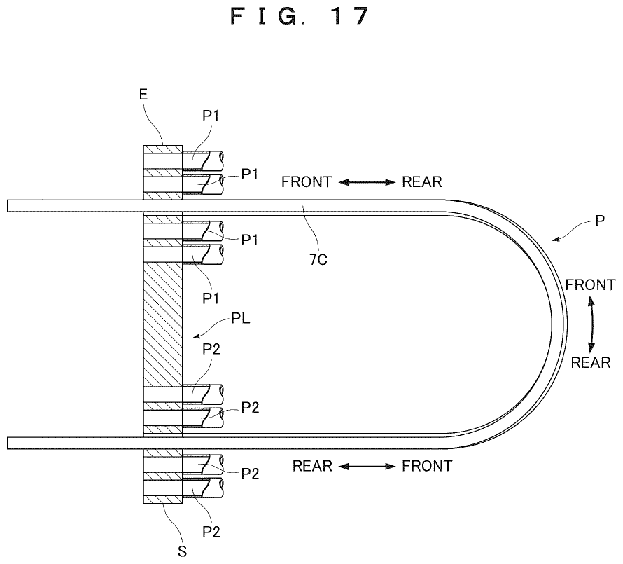

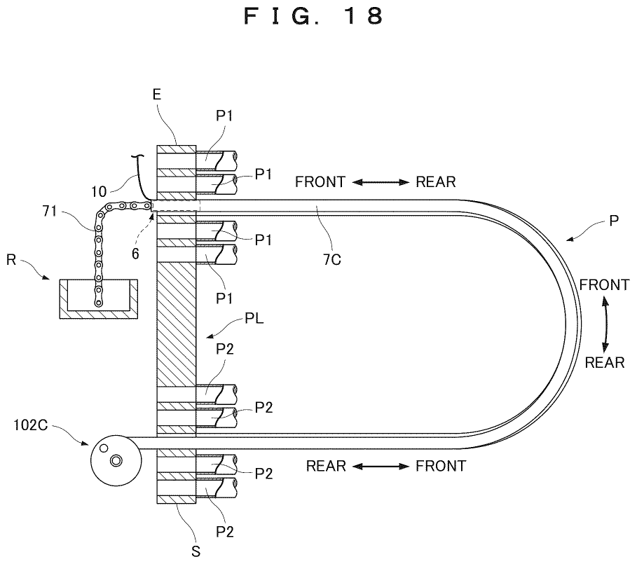

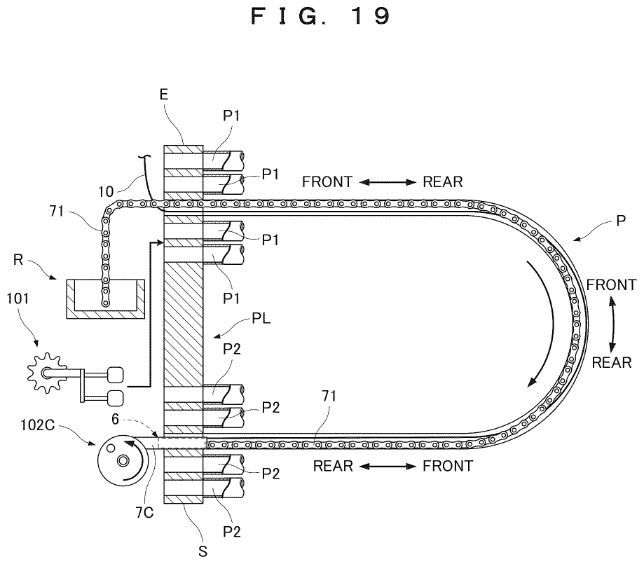

In the embodiments, as shown in FIGS. 7 and 8, an example has been described in which in the connection body installation step, the retracting chain 72 is passed through the tube P, and the connection body 6 is connected to the retracting chain 72. As shown in FIG. 16, however, a traction jig 7C (an example of a traction fitting) may be used instead of the retracting chain 72. The traction jig 7C has a slit extending in the longitudinal direction so that the traction jig 7C can be opened at the slit (that is, the traction jig 7C has a C-shaped lateral cross section). The traction jig 7C is a corrugated tube having a slit extending in the longitudinal direction, for example. When the traction jig 7C is used instead of the retracting chain 72, as shown in FIG. 17, in the connection body installation step, the traction jig 7C is passed through the tube P to be inspected. As shown in FIG. 18, the connection body 6 is then inserted into a front end part of the traction jig 7C at the inspection end side E of the tube P. The front end part of the traction jig 7C may be provided with an attachment that enables or facilitates the insertion of the connection body 6. The advancing chain 71 is connected to the connection body 6 inserted in the front end part of the traction jig 7C. Furthermore, a jig winding device 102C is installed outside the inspection start side S of the tube P so that the jig winding device 102C can wind up the traction jig 7C. The jig winding device 102C is a winding device for a water hose, for example.

As shown in FIG. 19, in the preliminary movement step, the jig winding device 102C then winds up the traction jig 7C. The connection body 6 is pulled in the backward direction and moves to the inspection start side S of the tube P. In other words, the retracting pulled part 62 of the connection body 6 is pulled to move the connection body 6 from the one end E to the other end S of the tube P. In addition, the advancing winding device 101 is fixed to the tubes P1 adjacent to (or in the vicinity of) the inspection end side E of the tube P. The advancing chain 71 is then passed through the advancing winding device 101 so that the advancing winding device 101 can wind up the advancing chain 71. Furthermore, the traction jig 7C is removed from the connection body 6 having moved to the other end S of the tube P, and the retracting chain 72 is connected to the connection body 6 instead. In addition, the retracting winding device 102 is fixed to the tubes P2 adjacent to (or in the vicinity of) the inspection start side S of the tube P. The retracting chain 72 is then passed through the retracting winding device 102 so that the retracting winding device 102 can wind up the retracting chain 72. The connection body installation step and the preliminary movement step described with reference to FIGS. 17 to 19 facilitate the movement of the array probes 4 and 5 along with the connection body 6 to the inspection start side S. The inspection step following the preliminary movement step is as described with reference to FIGS. 10 to 12.

### INDUSTRIAL APPLICABILITY

The present invention provides an ultrasonic phased array inspection device and an ultrasonic phased array inspection method using the same and has an industrial applicability.

1. An ultrasonic phased array inspection device, comprising:
a flexible plate extending along an inner circumferential surface of a tube;
an array probe that is disposed on the flexible plate and sends and receives an ultrasonic wave based on a phased array technique; and
a connection body that is connected to the flexible plate,
wherein the array probe has a set of a predetermined number of piezoelectric elements arranged in an inner circumferential direction of the tube, and
the connection body has a force receiving part that receives a force to make the connection body move in an axial direction of the tube.

2. The ultrasonic phased array inspection device according to claim 1,
wherein the array probe has a plurality of array probes, and
the plurality of array probes are located at different positions in the axial direction of the tube.

3. The ultrasonic phased array inspection device according to claim 2,
wherein the plurality of array probes cover at least an entire length in the inner circumferential direction of the tube.

4. The ultrasonic phased array inspection device according to claim 1, further comprising a hydrophilic protection film that protects the array probe.

5. The ultrasonic phased array inspection device according to claim 1, wherein the force receiving part is a pulled part that is pulled in the axial direction of the tube, and
the pulled part has:
an advancing pulled part that is pulled in one direction along the axial direction of the tube; and
a retracting pulled part that is pulled in another direction along the axial direction of the tube.

6. The ultrasonic phased array inspection device according to claim 5, further comprising:
an advancing traction member for pulling the advancing pulled part;
an advancing winding device that winds up the advancing traction member;
a retracting traction member for pulling the retracting pulled part; and
a retracting winding device that winds up the retracting traction member.

7. An ultrasonic phased array inspection method that uses the ultrasonic phased array inspection device according to claim 1, comprising:
performing flaw detection and/or thickness measurement with the array probe while moving the connection body.

8. An ultrasonic phased array inspection method that uses the ultrasonic phased array inspection device according to claim 5, comprising:
installing the connection body at one end of the tube;
moving the connection body from the one end to another end of the tube by pulling the retracting pulled part of the connection body; and
performing flaw detection and/or thickness measurement with the array probe while moving the connection body from the another end to the one end of the tube by pulling the advancing pulled part of the connection body.
